(19) United States
(12) Patent Application Publication
(10) Pub. No.: US 2015/0345578 A1
(43) Pub. Date: Dec. 3, 2015

(54) BRAKE COOLING

(71) Applicant: JAGUAR LAND ROVER LIMITED, Coventry Warwickshire (GB)

(72) Inventors: Hugo NIGHTINGALE, Leamington Spa (GB); Mark COLLINS, Warwick (GB); Richard D' ARCY, Coventry (GB)

(21) Appl. No.: 14/761,598

(22) PCT Filed: Jan. 16, 2014
(86) PCT No.: PCT/EP2014/050815

§ 371 Date: Jul. 16, 2015

(30) Foreign Application Priority Data
Jan. 17, 2013 (GB) 1300872.7

(51) Int. Cl. F16D 65/12; B60T 5/00; F16D 65/847

(52) U.S. Cl. CPC F16D 65/128; F16D 65/847; B60T 5/00; F16D 2065/783

(57) ABSTRACT

The present invention relates to a brake cooling system (1) for a motor vehicle (V), The brake cooling system (1) includes a bifurcated intake (3) having a first inlet (11) in communication with an air guide duct (5) and a second inlet (13) in communication a brake cooling duct (7), A control member (17) is movable between an open position and a closed position. The second inlet (13) is open when the control member (17) is in the open position; and is closed when the control member (I3) is in the closed position. The present invention also relates to s vehicle (V) having first and second brake cooling systems (1) of the type described herein on the left and right hand sides. The present invention also relates to an air intake (3) having first and second inlets (11, 13).

### TECHNICAL FIELD

The present invention relates to a brake cooling system for a motor vehicle; a vehicle; and an air intake for a brake cooling system.

BACKGROUND OF THE INVENTION

It is known from C3B 2357477 to provide a vehicle brake cooling system which includes brake cooling ducts. An opening is provided in the bumper cover panel and a movable closure flap is provided to direct air travelling across the front of the vehicle into the duct. The closure flap can be displaced to a closed position in which it is flush with the panel thereby improving the aerodynamics of the vehicle.

DE 10 2008 019 923 discloses a series of inlets for supplying air into the wheel arch to cool the brake systems associated with the front wheels of a motor vehicle. A pivotally mounted flap is provided behind each front wheel to control the airflow exiting the wheel arch.

It is against the background of this, prior art that the present invention has been conceived. At least in certain embodiments, the present invention can ameliorate or overcome at least some of the shortcomings associated with prior art systems.

### SUMMARY OF THE INVENTION

Aspects of the present invention relate to a brake cooling system for a motor vehicle; a vehicle; and an air intake for a brake cooling system as claimed in the appended claims.

According to a further aspect of the present invention, there is provided a cooling system for a motor vehicle, the cooling system comprising: a bifurcated intake having a first inlet for communicating with an air guide duct and a second inlet in communication with a cooling duct; and a first control member movable between an open position in which said second inlet is open and a closed position in which said second inlet is closed.

By opening and dosing the second inlet, airflow through the cooling duct, to be used to cool components of the vehicle which may become hot in use, can be controlled.

According to a further aspect of the present invention, there is provided a brake cooling system for a motor vehicle, the brake cooling system comprising:

a bifurcated intake having a first inlet in communication with an air guide duct and a second inlet in communication with a brake cooling duet; and

a control member movable between an open position in which said second inlet is open and a closed position in which said second inlet is closed. The control member is configured to control airflow through the brake cooling duct and optionally also the air guide duct. The control member can selectively open and dose the second inlet to control airflow through the brake cooling duct, in use, the control member can be displaced to said open position to open the brake cooling duct to direct airflow over a vehicle brake system to provide cooling, for example when a brake temperature exceeds a threshold. When cooling is not required, the control member can be displaced to said closed position to close the brake cooling duct to inhibit airflow over the vehicle brake system. At least in certain embodiments, the aerodynamic efficiency of the vehicle can be improved by closing the brake cooling duct.

The air guide duct can be arranged operatively to direct airflow through one or more side vents. The airflow exiting the side vent(s) can flow laterally outwardly from the vehicle to reduce aerodynamic losses. In use, the airflow can form a shield for deflecting airflow past an outside of the wheel. The brake cooling duct can operatively direct airflow in-board of the wheel. The airflow exiting the brake cooling duct flows over the vehicle brake system, for example over a brake disc and/or brake callipers.

The first inlet could be disposed above or below the second inlet. Alternatively, the first inlet can be disposed alongside the second inlet The second inlet can be disposed in-board (i.e. inset towards the middle of the vehicle) of the first inlet. When in said closed position, the control member can be configured to guide air towards the first inlet. An outer surface of the control member could be profiled to guide air into the first inlet. For example, the outer surface of the control member could comprise a concave section.

The first inlet can remain open when said control member is in said closed position. The air guide duct can thereby remain open irrespective of whether the brake cooling duct is open or closed. Alternatively, the first inlet can be closed when the control member is in-said closed position. The control member could be arranged to open and close the first and second inlets together or independently of each other. The control member could be arranged to open and close the first and second inlets sequentially, for example to open/close the first inlet followed by the second inlet or vice versa. A further alternative would be to provide a separate control member movable selectively to open and close the first inlet.

The control member could be hingedly, pivotally, rotatably or slidably mounted. Alternatively, the control member could be deformable and, in use, move between said open and closed positions by deforming. The control member can comprise a guide vane, for example arranged at least partially to cover or obstruct the second inlet when in said closed position. The control member could optionally also comprise a flange. The control member can be displaced at least partially into the brake cooling duct when moved to said open position. The control member could equally be a valve member, for example a butterfly valve, disposed in the brake cooling duct.

An actuator can be provided for displacing the control member to said open position and/or said closed position. A spring member could be provided to apply a spring bias towards said open position or said closed position. The brake cooling system could also comprise a controller configured to operate the actuator. The controller could, for example be configured to displace the control member to said open position when a brake temperature is greater than or equal to a predefined temperature threshold. The brake temperature could be measured or modelled. Alternatively, or in addition, the controller could be configured to operate the actuator to displace said control member-to the open position when a particular vehicle operating mode is selected. For example, the controller could open the brake cooling duct when a ‘Sport’ or ‘Track’ mode is selected.

The brake cooling system can comprise a stop for limiting movement of said control member. The stop could be formed integrally with a fairing, for example formed in the front apron of the vehicle. The front apron can form a bumper or skirt provided at the front of the vehicle.

According to a further aspect of the present invention, there is provided a vehicle comprising first and second brake cooling systems as claimed in any one of the preceding claims, wherein the first and second brake cooling systems are disposed on the left and right hand sides respectively of the vehicle. The first and second brake systems are positioned at the front of the vehicle operatively to provide cooling of the front brakes of the vehicle. The first and second brake cooling systems can be disposed in a front apron of the vehicle. The front apron can comprise a front splitter for splitting the airflow travelling under the vehicle and over the vehicle. The first and second brake cooling systems can be positioned above the front splitter. The control member can comprise a forward-facing flange for cooperating with an upper surface of the front splitter.

According to a yet further aspect of the present invention, there is provided an air intake for a motor vehicle, the air intake comprising:
a first inlet for communicating with a first duct;
a second inlet for communicating with a second duct; and
a control member configured selectively to open and close at least said first inlet.

The air intake can comprise a bifurcated inlet forming said first and second inlets.

The control member can be configured selectively also to open and close said second inlet. Alternatively, a second control member can he provided for selectively opening and closing the second inlet. The control member can be movably mounted, for example to undergo pivotal, translational or rotational movement.

The first inlet can be a first cooling inlet for directing air into a first cooling duct. The second inlet can be a second cooling inlet for directing air into a second cooling duct. For example, the first cooling inlet can be arranged to supply cooling airflow to a vehicle brake system, such as s brake calliper. The second cooling inlet can be arranged to supply cooling airflow to an electric machine, such as a traction motor or a generator.

An actuator can be provided for displacing said first control member to said open position and/or said closed position. The actuator can, for example, be an electric machine or a piston. A resilient member, such as a spring, can be provided for returning the first control member to said open position or said closed position.

A controller can be provided for controlling operation of the actuator. The controller can be configured to operate said actuator selectively to displace said control member to said open position when a temperature is greater than or equal to a predefined temperature threshold. The temperature can be measured or modelled, for example based on brake or engine usage. Alternatively, or in addition, the controller-can be configured to operate said actuator to displace said control member to said open position when one or more defined vehicle operating modes are selected, such as a sport or track mode.

The first inlet can be a first air guide inlet for supplying air to a first air guide vent. The second inlet can be a second air guide inlet for supplying air to a second air guide vent. The first air guide vent and/or the second air guide vent can he configured to control the flow of air around the vehicle, for example to establish a transverse jet of air in front of the front wheels of the vehicle. The first air guide inlet and/or the second air guide inlet can be selectively opened/closed to control the flow of air. For example, the first and second air guide vents could fee selectively opened/closed in response to the vehicle speed. The first and second air guide vents can be offset from each other on the same side of the vehicle to provide different airflow characteristics.

The first and second ducts could be arranged to supply air to other vehicle systems. The first duct could be arranged to supply air to an engine manifold. The first duct could remain open continuously or could be opened selectively, for example to supply additional air to the engine manifold under high engine loads. The second duel could be arranged to supply air to an engine compartment or a radiator, for example to perform additional cooling.

The first and second ducts can be formed integrally with the air intake. Alternatively, the first and second ducts can be coupled to said first and second inlets respectively. The present invention also relates to an airflow control system comprising an air intake as described herein in combination with one or more air ducts. The airflow control system can also comprise one or more air guide vents.

According to a further aspect of the present invention there is provided a vehicle comprising at least one of the air intakes described herein. The vehicle can comprise first and second air intakes disposed on respective first and second sides of the vehicle. The first and second air intakes can, for example, be disposed in a front bumper or valence of the vehicle. In use, the first and second air intakes can selectively supply a cooling airflow to affect cooling of left and right brake systems for the front wheels of the vehicle. The first and second air intakes can selectively supply airflow to left and right air guide vents disposed on the left and right hand sides of the vehicle. The left and right air guide vents can be disposed in front of the front wheels of the vehicle and arranged, in use, to direct a transverse jet of air in front of the respective wheels.

Within the scope of this application it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

Embodiments of the present invention will now be described, by way of example only, with reference to the accompanying figures, in which;

FIG. 1 shows a semi-transparent perspective view of a brake cooling system according to an embodiment of the present invention:

FIG. 2 shows a sectional plan view of the brake cooling system according to the present invention; and

FIGS. 3 and 4 show an air intake of the brake cooling system according to the present invention in closed and open positions respectively.

### DETAILED DESCRIPTION OF AN EMBODIMENT

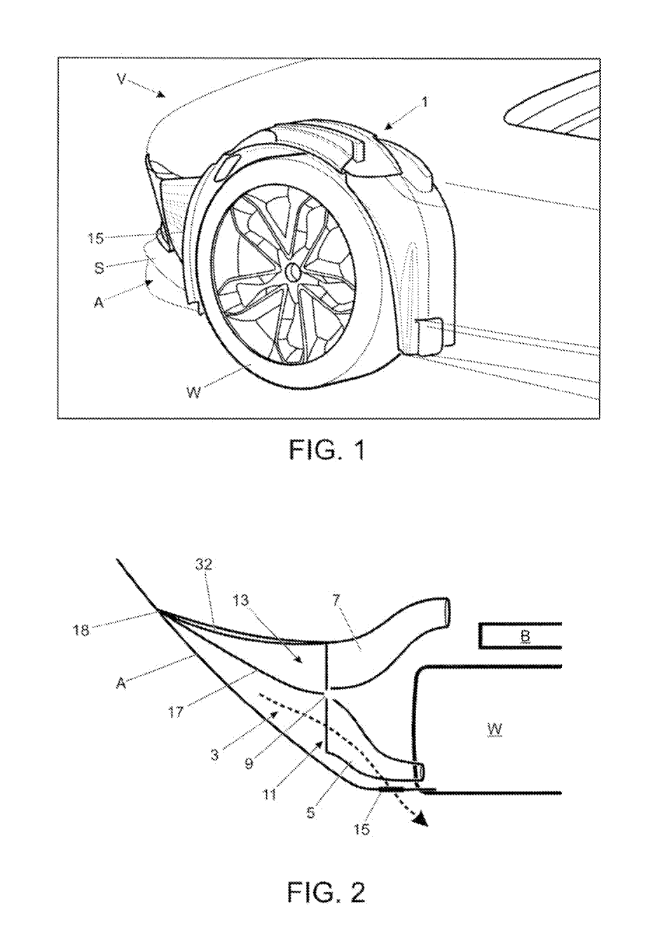

A brake cooling system 1 in accordance with an embodiment of the present invention will now be described-with reference to FIGS. 1 to 3, The brake cooling system 1 is disposed in a lower front apron A of a motor vehicle V in front of the front wheels W. In use, the brake cooling system 1 is configured to control airflow over a brake system B associated with a front wheel W of the vehicle. The brake cooling system 1 is duplicated on the left and right hand sides of the vehicle V, but is described herein with reference to the left hand side of the vehicle for the sake of brevity.

As shown in FIG. 2, the brake cooling system 1 comprises an air intake 3, an air guide duct 5 and a brake cooling duct. The air intake 3 is moulded as a single piece from a composite material, for example carbon fibres embedded in a resin. The air intake 3 is inset from the surrounding front apron A to form an intake chamber disposed above a front splitter S formed integrally with the apron A. The air intake 3 is bifurcated operatlvely to direct airflow into the air guide duct 5 and into the brake cooling duct 7. Specifically, the air intake 3 comprises a fixed vertical guide member 9 which divides the air intake 3 into a first inlet 11 associated with the air guide duct 5 and a second inlet 13 associated with the brake cooling duct 7. The first and second inlets 11, 13 are adapted to direct airflow into the air guide duel 5 and the brake cooling duct 7 respectively. The air guide duct 5 is adapted to direct airflow laterally outwardly through a vertical vent 15 positioned at a side of the apron A in front of the front wheel W of the vehicle. The airflow exiting the vent 15 can help to control the airflow past an outside of the front wheel VV to reduce aerodynamic drag. Specifically, when the vehicle is moving, airflow exiting the vent 15 forms a shield for at least a portion of the front wheel W. An outlet from the air guide duct 15 can optionally also be provided into a wheel well in front of the wheel W. The brake cooling duct 7 is adapted to direct airflow in-board of the front wheel W to improve airflow over the brake system B. In particular, the brake cooling duct 7 is operative to establish airflow over the brake callipers and/or the discs (not shown) to provide additional cooling. The airflow from the brake cooling duct 7 can also control the passive air within the wheel arch.

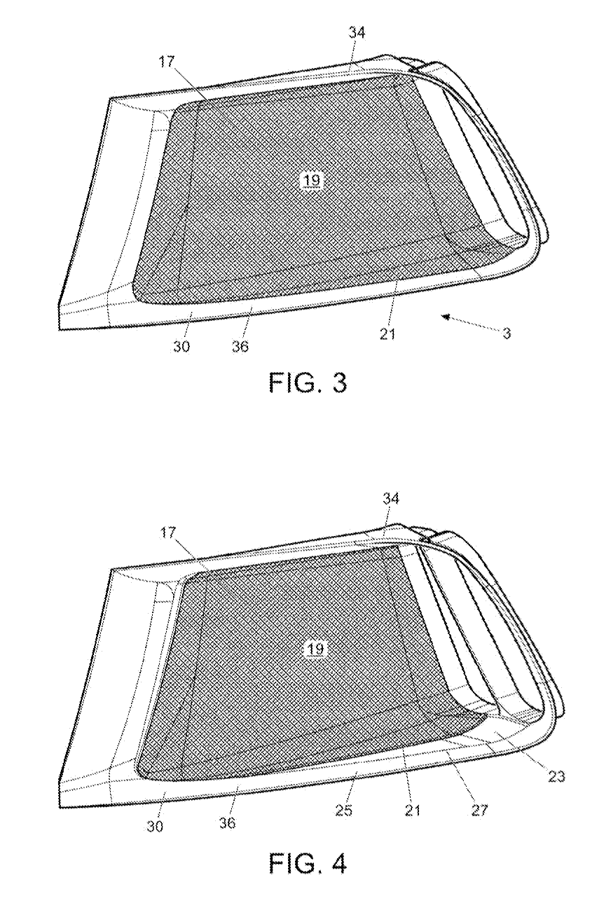

A control member 1 is pivotally mounted to the air intake 3 to selectively open/close the brake cooling duct 7. In the present embodiment, the control member 17 is mounted at a front (leading) edge 18 by a hinge (not shown). The control member 1 is movable between a closed position (as shown in FIG. 3) and an open position (as shown in FIG. 4). The control member 17 comprises a vertical guide vane 19 and an outwardly directed flange 21. The flange 21 is a continuation of a lower edge of the guide vane 19 and strengthens the control member 17 to prevent deflection of the guide vane 19. The flange 21 locates in a recess 23 formed in a lower surface 25 of the air intake 3 to define a continuous (i.e. uninterrupted) intake surface when the control member 17 is in its closed position. The recess 23 also defines a slop 27 to limit forward movement of the control member 11.

The first inlet 11 remains open to allow air to enter the air guide duct 5 irrespective of the position of the control member 17. When the control member 17 is in said closed position, the guide vane 19 at least substantially closes the second inlet 13 thereby inhibiting the flow of air info the brake cooling duct 7. When the control member 17 is in said open position, the guide vane 19 is at least partially displaced into the brake cooling duct, thereby opening the second inlet 13 and allowing air to enter the brake cooling duct 7. The guide vane 19 can guide air exclusively into the air guide duct 5 when the control member 1 is in the closed position; or into both the air guide duct 5 and the brake cooling system 7 when the movable control member 9 is in the open position. An actuator (such as a solenoid or hydraulic piston) is provided actively to displace the control member 17 between said open and closed positions.

A controller (not shown) is provided for controlling the actuator to selectively open/close the brake cooling duct 7. The controller can be configured to operate the actuator in response to a brake temperature (either measured or modelled). For example, the controller can be configured to operate said actuator to displace the control member 17 to said open position when the temperature of the front brakes exceeds a predefined threshold; and/or in specific driving modes, such as a Sport or Track mode.

The operation of the brake cooling system 1 in accordance with the present invention will now be described. The control member 17 is maintained in said closed position during normal operating conditions. The incident airflow on the air intake 3 is directed exclusively through the first inlet 11 info the air guide duct 6. The air guide duct 5 directs the airflow laterally outwardly through the vent 15 at the front of the front wheel to form a vertically elongated jet of air which can function as a shield for the front wheel W to improve aerodynamic performance and efficiency. The airflow through the air guide duct 5 and the vent 15 is illustrated by a dashed arrow in FIG. 2. At least in certain embodiments, the lateral airflow can smooth airflow around the front wheel W and may also reduce air pressure within the wheel arch.

If the measured temperature of the front brake system is equal to or greater than the predefined threshold, the controller operates the actuator to displace the control member 1 to said open position. The control member 17 is displaced partially into the brake cooling duct , thereby opening the second inlet 13 and allowing air to enter brake cooling duct 7. When the control member 17 is in the open position, the incident airflow is directed into both the air guide duct 5 and the brake cooling duct 7 via the first and second inlets 11, 13 respectively. The airflow through the brake cooling duct 7 is directed to an inside of the front wheel W and flows over the brake systems before exiting at the rear of the wheel arch. The airflow introduced through the brake cooling duct 7 can thereby promote cooling of the brake system.

The controller could also be configured to control the control member 17 in dependence on a selected vehicle operating mode. When an ‘Eco’ mode is selected, the control member 17 is displaced to said closed position to direct air exclusively into the first inlet 11. When a ‘Sport’ mode is selected, typically providing harder braking and/or acceleration, the controller displaces the control member 17 to said open position to direct air into both the first and second inlets 11, 13.

The control member 17 has been described as being pivotally mounted by way of a hinge at its leading edge, but it will be understood that it could alternatively be mounted by a live hinge (for example by forming the control member 17 and the hinge integrally from a resilient material), thus maintaining a continuous surface at its leading edge. Alternatively, the movable control member could be slidably mounted (for example, to retract adjacent to an inner surface of the front apron) or rotatably mounted (for example, to rotate inside the front apron).

In the embodiment described previously, when the control member 17 is in the closed position, the guide vane 19 at least substantially closes the second inlet 13 thereby inhibiting the flow of air info the brake cooling duct. When the second inlet 13 is open, the inlet forms an aperture in the A surface of the vehicle. Some of the air which would otherwise have been incident on and/or deflected by the A surface, for example when the vehicle moves, will instead pass through the inlet to enter the brake cooling duct 7. The skilled person would understand that by “closed” is meant that there is no direct fluid communication between the inlet 13 and air exterior to the A surface of the vehicle, such that air flow incident on the exterior or A surface of the vehicle, for example due to movement of the vehicle, cannot pass through the second inlet 13 to reach the brake cooling duct. The air intake area 3 has a housing 30 comprising a rear wall 32, hidden from view behind the control member 17, and a top wall 34 and a bottom wall 36. When the control member 17 is in the closed position, the second inlet 13 is enclosed by the control member 17, a portion of the top wail 34, the rear wall 32, and a portion of the bottom wall 38.

In an alternative embodiment, one or more of the rear wall, the top wall, and the bottom wall may not be present (or indeed the entire housing may not be present, the control member instead being hinged directly to another portion of the vehicle body, and the first and second inlets simply being defined by the end of the air guide duct and brake cooling duct, or being attached thereto, or to another portion of the vehicle body), in such art arrangement, when the control member 17 is in the closed position, the second inlet 13 may not be enclosed as in the previous embodiment. However, the second inlet 13 would still be considered “closed” for the purposes of the invention, as, although the inlet 13 may be open to air behind the A surface, it is still cut off from or closed to the flow of air that is incident on the A surface when the vehicle is in motion. There is no direct fluid communication path between the air exterior the A surface of the vehicle and the inlet 13. In effect, the inlet 13 is no longer formed in the A surface, or outermost surface, of the vehicle when the control member 17 is closed. The A surface prevents direct fluid communication between any air flow and the inlet 13.

The control member 17 has been described as selectively opening/closing the brake cooling duct 7 whilst maintaining the air guide duct 5 open. An alternative configuration could enable the air guide duct S and the brake cooling duct 7 to be selectively opened/closed independently of each other. Equally, the control member 17 could be configured to close the air guide duct 5 when the brake cooling duct 7 is open.

The cooling system 1 described herein could also be utilised selectively to direct airflow over components of the vehicle, other than the brakes, which may need cooling in use. For example, the cooling system could be utilised selectively to direct airflow over an electric drive motor, for example in a hybrid electric vehicle or an electric vehicle, and/or a turbocharger and/or an inverter.

Furthermore, the control member 17 could be controlled to alter lateral aerodynamic loading on the vehicle. For example, the control members 17 provided in the brake cooling systems 1 on the left and right hand sides of the vehicle V could be operated independently of each other to control lateral aerodynamic loads. This technique could he used to control aerodynamic loads caused by side winds. Alternatively, or in addition, the technique could be used as an active driver aid, for example to create a lateral aerodynamic load to assist with turning the vehicle, in a modified arrangement, the control members 17 could also selectively open and dose the first inlet 11 to control airflow through the air guide duct 5. The opening and closing of the first and second inlets 11, 13 could be controlled independently.

In the embodiment described herein, art actuator is provided for actively controlling the control member 17. An alternate approach would be to use aerodynamic loading to displace the control member 17 to said open/closed positions.

It will be appreciated that various changes and modifications can be made to the movable control member described herein without departing from the scope of the present invention,

Aspects of the present invention will he described with reference to the following numbered paragraphs.
1. A brake cooling system for a motor vehicle, the brake cooling system comprising:
   a bifurcated intake having a first inlet in communication with an air guide duct and a second inlet in communication with a brake cooling duct: and
   a control member movable between an open position in which said second inlet is open and a closed position in which said second inlet is closed.
2. A brake cooling system as described in paragraph 1, wherein the air guide duct operatively directs airflow laterally outwardly through a side vent to flow past an outside of a wheel of the vehicle and the brake cooling duct operatively directs airflow inboard of said wheel.
3. A brake cooling system as described in paragraph 1, wherein the first inlet remains open when said control member is in said closed position.
4. A brake cooling system as described in paragraph 1, wherein the first inlet is closed when said control member is in said closed position.
5. A brake cooling system as described in paragraph 1, wherein the control member is hingedly, pivotally, rotatably or slidably mounted.
6. A brake cooling system as described in paragraph 1 comprising an actuator for displacing said control member to said open position and/or said closed position.
7. A brake cooling system as described in paragraph 8 comprising a controller configured to operate said actuator to displace said control member to said open position when a brake temperature is greater than or equal to a predefined temperature threshold; and/or when one or more denned vehicle operating modes are selected.
8. A brake cooling system as described in paragraph 1 wherein the control member comprises a guide vane and optionally also a flange.
9. A brake cooling system as described in paragraph 1, wherein a stop is provided for limiting movement of said control member.
10. A vehicle comprising first and second brake cooling systems as described in paragraph 1, wherein the first and second brake cooling systems are disposed on the left and right hand sides respectively of the vehicle.
11. A vehicle as described in paragraph 1, wherein the first and second brake cooling systems are disposed in a front apron of the vehicle.
12. An air intake for a motor vehicle, the air intake comprising:
   a first inlet for communicating with a first duct;
   a second inlet for communicating with a second duct; and
   a first control member configured selectively to open and close at least said first
   inlet.
13. An air intake as described in paragraph 12, wherein the first control member is configured selectively also to open and close said second inlet.
14. An air intake as described in paragraph 12, wherein the first inlet is a first cooling inlet for directing air into a first cooling duct; and/or the second inlet is a second cooling inlet for directing air into a second coding duct.
15. An air intake as described in paragraph 12 comprising an actuator for displacing said first control member to said open position and/or said closed position.
18. An air intake as described in paragraph is comprising a controller configured to operate said actuator selectively to displace said control member to said open position when a temperature is greater than or equal to a predefined temperature threshold; and/or when one or more defined vehicle operating modes are selected.
17. An air intake as described in paragraph 12, wherein the first inlet is a first air guide inlet for supplying air to a first air guide vent; and/or the second inlet is a second air guide inlet for supplying air to a second air guide vent.
18. An air intake as described in paragraph 12, wherein the air intake comprises a second control member configured selectively to open and close said second inlet.

1. A cooling system for a motor vehicle, the cooling system comprising:
a bifurcated intake having a first inlet for communicating with an air guide duct and a second inlet in communication with a cooling duct; and
a first control member movable between an open position in which said second inlet is open and a closed position in which said second inlet is closed, wherein the air guide duct operatively directs airflow laterally outwardly through a side vent to flow past an outside of a wheel of the vehicle and the cooling duct operatively directs airflow inboard of said wheel to a component of the vehicle to be cooled.

2. A cooling system according to claim 1, wherein the cooling system is a brake cooling system and the cooling duct is a brake cooling duct.

3. (canceled)

4. A cooling system according to claim 1, wherein the cooling system is at least one from an engine cooling system, a turbocharger cooling system, an inverter cooling system, and a transmission cooling system, and the cooling duct is at least one, respectively, from an engine cooling duct, a turbocharger cooling duct, an inverter cooling duct, and a transmission cooling duct.

5. A cooling system as claimed in claim 1, wherein the first inlet remains open when said control member is in said closed position, or wherein the first inlet is closed when said control member is in said closed position.

6. (canceled)

7. A cooling system as claimed in claim 1, wherein the control member is hingedly, pivotally, rotatably or slidably mounted.

8. A cooling system as claimed in claim 1 comprising an actuator for displacing said control member to said open position and/or said closed position.

9. A cooling system as claimed in claim 2, comprising an actuator for displacing said control member to said open position and/or said closed position and comprising a controller configured to operate said actuator to displace said control member to said open position when a brake temperature is greater than or equal to a predefined temperature threshold; and/or when one or more defined vehicle operating modes are selected.

10. A cooling system as claimed in claim 1, wherein the control member comprises a guide vane.

11. A cooling system as claimed in claim 1, wherein a stop is provided for limiting movement of said control member.

12. A vehicle comprising first and second brake cooling systems as claimed in claim 2, wherein the first and second brake cooling systems are disposed on the left and right hand sides respectively of the vehicle.

13. A vehicle as claimed in claim 12, wherein the first and second brake cooling systems are disposed in a front apron of the vehicle.

14-23. (canceled)

24. A brake cooling system for a motor vehicle, the brake cooling system comprising:
a bifurcated intake having a first inlet in communication with an air guide duct and a second inlet in communication with a brake cooling duct; and
a control member movable between an open position in which said second inlet is open and a closed position in which said second inlet is closed.

25. A brake cooling system as claimed in claim 24, wherein the first inlet remains open when said control member is in said closed position, or wherein the first inlet is closed when said control member is in said closed position.

26. A brake cooling system as claimed in claim 24, wherein the control member is hingedly, pivotally, rotatably or slidably mounted.

27. A brake cooling system as claimed in claim 24, comprising an actuator for displacing said control member to said open position and/or said closed position.

28. A brake cooling system as claimed in claim 27, comprising a controller configured to operate said actuator to displace said control member to said open position when a brake temperature is greater than or equal to a predefined temperature threshold; and/or when one or more defined vehicle operating modes are selected.

29. A brake cooling system as claimed in claim 24, wherein the control member comprises a guide vane and optionally also a flange.

30. A brake cooling system as claimed in claim 24, wherein a stop is provided for limiting movement of said control member.

31. A vehicle comprising first and second brake cooling systems as claimed in claim 24, wherein the first and second brake cooling systems are disposed on the left and right hand sides respectively of the vehicle.

32. A vehicle as claimed in claim 31, wherein the first and second brake cooling systems are disposed in a front apron of the vehicle.
